(19) United States
(12) Patent Application Publication
(10) Pub. No.: US 2024/0201316 A1
(43) Pub. Date: Jun. 20, 2024

(54) MOBILE TERMINAL AND CONTROL METHOD

(71) Applicant: NIPPON TELEGRAPH AND TELEPHONE CORPORATION, Tokyo (JP)

(72) Inventors: Takeshi IMAI, Musashino-shi, Tokyo (JP); Naotaka SHIBATA, Musashino-shi, Tokyo (JP); Kazutaka HARA, Musashino-shi, Tokyo (JP); Ryo IGARASHI, Musashino-shi, Tokyo (JP)

(73) Assignee: NIPPON TELEGRAPH AND TELEPHONE CORPORATION, Tokyo (JP)

(21) Appl. No.: 18/288,011

(22) PCT Filed: May 20, 2021
(86) PCT No.: PCT/JP2021/019192

§ 371 Date: Oct. 23, 2023

(51) Int. Cl. G01S 5/16

(52) U.S. Cl. CPC G01S 5/16

(57) ABSTRACT

A mobile terminal according to the present invention is configured to: acquire position information from a lighting device which transmits the position information by a change in a light output mode; derive a first distance between a first coordinate and a terminal projection position, the first coordinate indicating a position obtained by projecting, on a projection plane parallel to a floor surface, a first lighting device from which first position information is acquired as the position information, and the terminal projection position being obtained by projecting the mobile terminal on the projection plane; derive a second distance between a second coordinate and the terminal projection position, the second coordinate indicating a position obtained by projecting, on the projection plane, a second lighting device from which second position information is acquired as the position information; acquire a rotation angle of rotation of the mobile terminal on the projection plane from acquisition of the first position information to acquisition of the second position information; and estimate a coordinate indicating the terminal projection position based on the first coordinate, the first distance, the second coordinate, the second distance, and the rotation angle.

### TECHNICAL FIELD

The present invention relates to a mobile terminal and a control method.

### BACKGROUND ART

As outdoor position estimation techniques using the Global Positioning System (GPS) have been developed, a user can know a his/her own outdoor position. In addition, there is a demand for a position notification system for recognizing an indoor position. As a technique used in a position notification system, there are a technique using geomagnetism, a technique using Wi-Fi (registered trademark), and a technique using visible light (for example, refer to Non Patent Literature 1).

In the technique using visible light, as illustrated in FIG. 7, a dedicated lighting device is used as a lighting device provided on a ceiling. The dedicated lighting device is an LED illumination including a driver circuit for modulating an ID and the like. Thus, the dedicated lighting device is more expensive than a normal LED illumination. The dedicated lighting device can transmit various types of information such as position information according to a light output mode such as light blinking or a color change. In FIG. 7, a mobile terminal is located in a region in which position information 011 can be received. The position information 011 is associated with a map, and thus the mobile terminal can acquire a position on the map.

### CITATION LIST

### Non Patent Literature

Non Patent Literature 1: “Indoor Positioning System” using Visible Light Communication, Internet (URL:https://www.signify.com/ja-jp/our-company/news/press-release-archive/2017/20170221-philips-lighting-introduces-advanced-connected-lighting-solutions)

### SUMMARY OF INVENTION

### Technical Problem

In the related art, it is assumed that the mobile terminal is within a range in which light from a lighting device which transmits certain position information reliably reaches. As a result, an operation in a region in which the light does not easily reach, such as a region near an irradiation range which is directly irradiated with the light from the lighting device, is not considered. That is, in a case where the mobile terminal is located in a region in which the light does not easily reach, it is difficult to acquire a position of the mobile terminal.

In addition, pieces of position information from a plurality of lighting devices may be received near the irradiation range directly irradiated with the light. However, a case where a plurality of pieces of position information are received is not considered.

In order to expand a range in which the position can be acquired, a method of increasing the number of lighting devices which transmit the position information, a method of expanding the irradiation range of the lighting device which transmits the individual position information, or the like is used. However, in the former, a cost for installation is required, and in the latter, accuracy of position estimation is deteriorated.

The present invention has been made in view of the above circumstances, and an object of the present invention is to provide a technique capable of estimating a position of the mobile terminal in a case where the mobile terminal is located outside the irradiation range which is directly irradiated with light.

### Solution to Problem

According to an aspect of the present invention, there is provided a mobile terminal including: a position information acquisition unit that acquires position information from a lighting device which transmits the position information by a change in a light output mode; a first derivation unit that derives a first distance between a first coordinate and a terminal projection position, the first coordinate indicating a position obtained by projecting, on a projection plane parallel to a floor surface, a first lighting device from which first position information is acquired as the position information by the position information acquisition unit, and the terminal projection position being obtained by projecting the mobile terminal on the projection plane; a second derivation unit that derives a second distance between a second coordinate and the terminal projection position, the second coordinate indicating a position obtained by projecting, on the projection plane, a second lighting device from which second position information is acquired as the position information by the position information acquisition unit; a rotation angle acquisition unit that acquires a rotation angle of rotation of the mobile terminal on the projection plane from acquisition of the first position information to acquisition of the second position information; and a coordinate estimation unit that estimates a coordinate indicating the terminal projection position based on the first coordinate, the first distance, the second coordinate, the second distance, and the rotation angle.

According to an aspect of the present invention, there is provided a control method of a mobile terminal, the method including: a position information acquisition step of acquiring position information from a lighting device which transmits the position information by a change in a light output mode; a first derivation step of deriving a first distance between a first coordinate and a terminal projection position, the first coordinate indicating a position obtained by projecting, on a projection plane parallel to a floor surface, a first lighting device from which first position information is acquired as the position information in the position information acquisition step, and the terminal projection position being obtained by projecting the mobile terminal on the projection plane; a second derivation step of deriving a second distance between a second coordinate and the terminal projection position, the second coordinate indicating a position obtained by projecting, on the projection plane, a second lighting device from which second position information is acquired as the position information in the position information acquisition step; a rotation angle acquisition step of acquiring a rotation angle of rotation of the mobile terminal on the projection plane from acquisition of the first position information to acquisition of the second position information; and a terminal estimation derivation step of deriving a coordinate indicating the terminal projection position based on the first coordinate, the first distance, the second coordinate, the second distance, and the rotation angle.

### Advantageous Effects of Invention

According to the present invention, it is possible to estimate a position of the mobile terminal in a case where the mobile terminal is located outside the irradiation range which is directly irradiated with light.

### BRIEF DESCRIPTION OF DRAWINGS

FIG. 1 is a diagram illustrating a configuration example of a position estimation system 1.

FIG. 2 is a functional block diagram illustrating a functional configuration of a mobile terminal 40.

FIG. 3 is a diagram illustrating a specific example of a map database.

FIG. 4 is a diagram illustrating a mode when a ceiling 10 and a floor surface 30 are viewed from a lateral direction.

FIG. 5 is a diagram for explaining a method of estimating a coordinate of a terminal projection position P.

FIG. 6 is a functional block diagram illustrating a functional configuration of the mobile terminal 40.

FIG. 7 is a diagram illustrating a technique in the related art.

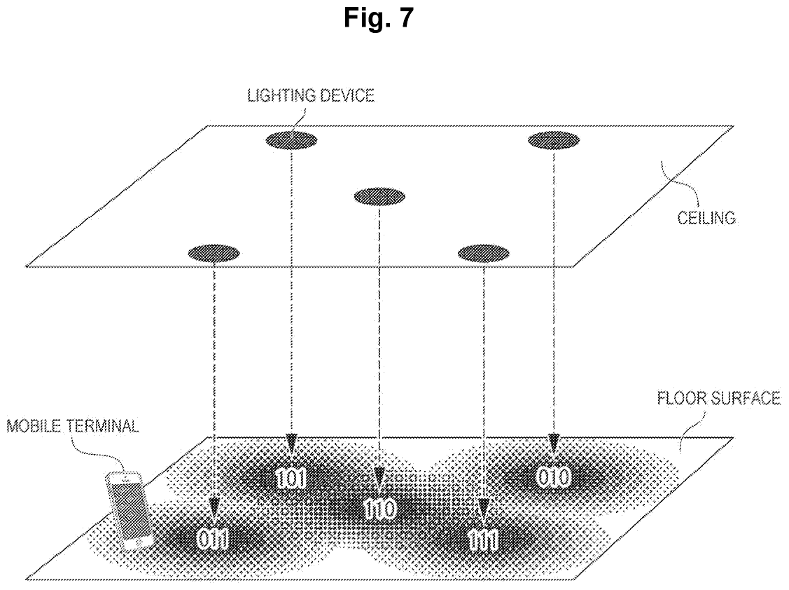

### DESCRIPTION OF EMBODIMENTS

Embodiments of the present invention will be described in detail with reference to the drawings.

### First Embodiment

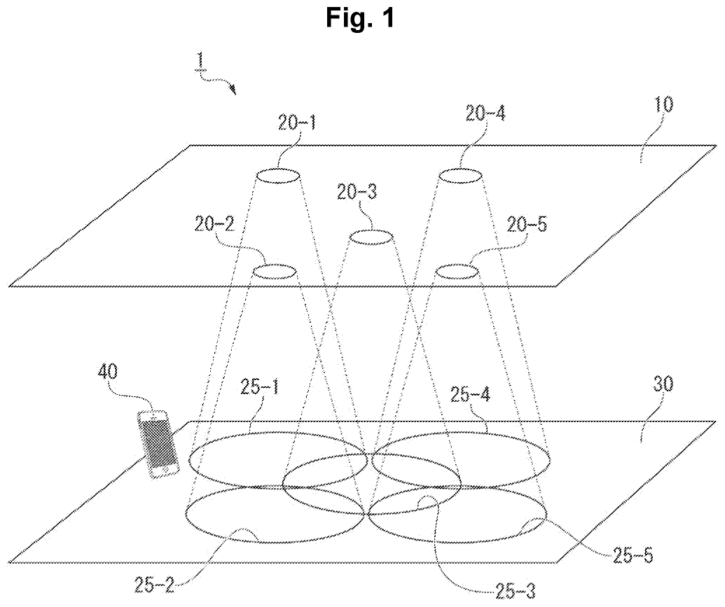

FIG. 1 is a diagram illustrating a configuration example of a system that estimates a position of a mobile terminal (hereinafter, referred to as a “position estimation system”). The position estimation system 1 includes a plurality of lighting devices 20-1, 20-2, 20-3, 20-4, and 20-5 provided on a ceiling 10. In the following description, in a case where the lighting devices 20-1, 20-2, 20-3, 20-4, and 20-5 are not distinguished from one another, the lighting devices are referred to as the lighting devices 20.

The lighting device 20 is an LED lighting device, and irradiates a floor surface 30 with light. Irradiation ranges 25-1, 25-2, 25-3, 25-4, and 25-5 drawn on the floor surface 30 are irradiation ranges obtained by respectively irradiating the floor surface 30 with light by the lighting devices 20-1, 20-2, 20-3, 20-4, and 20-5. In the following description, in a case where the irradiation ranges 25-1, 25-2, 25-3, 25-4, and 25-5 are not distinguished from each other, the irradiation ranges are referred to as the irradiation ranges 25.

The irradiation range 25 indicates a range in which light from the lighting device 20 is reliably reached. Therefore, even outside the irradiation range 25, the mobile terminal 40 can receive light in many cases as long as the mobile terminal 40 is located near the irradiation range 25. In the following description, it is assumed that the mobile terminal 40 can receive light near the irradiation range 25. It is assumed that the mobile terminal 40 is a smartphone.

The lighting device 20 can transmit a signal to the mobile terminal 40 by a change in a light output mode corresponding to position information (hereinafter, referred to as “ID”). In the present embodiment, a change in the light output mode will be described as a blinking pattern. An ID is uniquely assigned to a region irradiated with light by the lighting device 20, and the lighting device 20 transmits a signal to the mobile terminal 40 by a blinking pattern indicating the ID. Therefore, in a case where an ID is acquired, a region is specified from the ID, and thus it can be seen that a position of the mobile terminal 40 is a certain position within the region. The region is associated with a map, and thus the mobile terminal 40 can acquire a position on the map.

As illustrated in FIG. 1, in a case where the mobile terminal 40 is located near the irradiation ranges 25, the mobile terminal 40 acquires IDs from the plurality of lighting devices 20. In the case of FIG. 1, the mobile terminal 40 acquires IDs from the lighting devices 20-1 and 20-2. In this case, it can be seen that the mobile terminal 40 is located at least near the irradiation ranges 25-1 and 25-2.

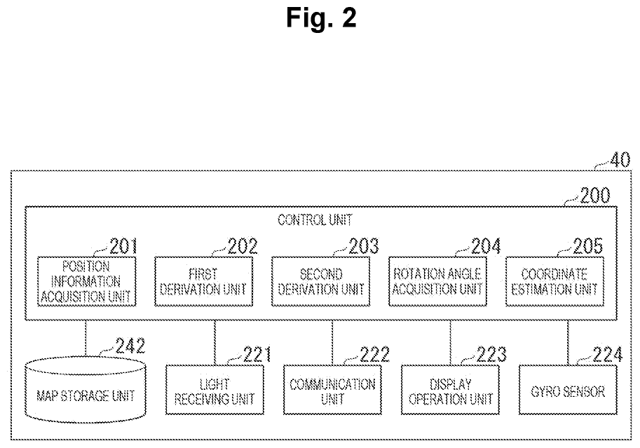

FIG. 2 is a functional block diagram illustrating a functional configuration of the mobile terminal 40. The mobile terminal 40 includes a CPU, a memory, an auxiliary storage device, and the like which are connected to each other via a bus, and functions as an apparatus including a control unit 200, a map storage unit 242, a light receiving unit 221, a communication unit 222, a display operation unit 223, and a gyro sensor 224 by executing an estimation program.

Note that all or some functions of each of the control unit 200 and the map storage unit 242 may be implemented using hardware such as an application specific integrated circuit (ASIC), a programmable logic device (PLD), or a field programmable gate array (FPGA). The estimation program may be recorded on a computer-readable recording medium. Examples of the computer-readable recording medium include a portable medium such as a flexible disk, a magneto-optical disk, a ROM, a CD-ROM, or a semiconductor storage device (for example, a solid-state drive (SSD)), and a storage device such as a hard disk included in a computer system.

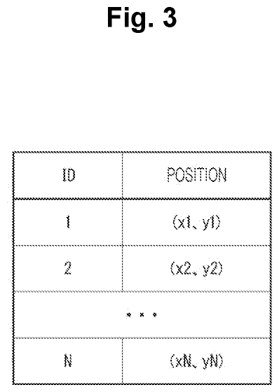

The map storage unit 242 is configured using a storage device such as a semiconductor storage device or a magnetic hard disk device. The map storage unit 242 stores a map database. FIG. 3 is a diagram illustrating a specific example of the map database. The map database includes an ID and a position.

The position indicates an installation position of the lighting device 20 by a coordinate. In the map indicated by map image data (not illustrated), a coordinate on an XY plane and a position on the map are associated with each other. The position indicates a coordinate on the XY plane. Therefore, in a case where the ID is known, a position on the map can be acquired.

Returning to FIG. 2, the light receiving unit 221 receives light emitted from the lighting device 20. The light receiving unit 221 includes, for example, a CCD sensor, an illuminance sensor, a photo diode (PD), or the like. The communication unit 222 performs various types of communication using a communication line such as 4G or 5G, a wireless LAN, Bluetooth (registered trademark), and the like. A management program for managing the mobile terminal 40, the estimation program, and a map information database may be transmitted and received via the communication unit 222. The display operation unit 223 includes a liquid crystal, an organic EL, a touch panel and a hard key, or the like. The gyro sensor 224 detects angles of a yaw axis, a pitch axis, and a roll axis of the mobile terminal 40.

The control unit 200 of FIG. 2 controls an operation of each unit of the mobile terminal 40. The control unit 200 is implemented by, for example, a device including a processor such as a CPU and a RAM. The control unit 200 functions as a position information acquisition unit 201, a first derivation unit 202, a second derivation unit 203, a rotation angle acquisition unit 204, and a coordinate estimation unit 205 by executing the estimation program.

The position information acquisition unit 201 acquires an ID from the lighting device 20. The first derivation unit 202 derives a first distance between a first coordinate indicating a position obtained by projecting a first lighting device on a projection plane parallel to the floor surface 30 and a terminal projection position obtained by projecting the mobile terminal 40 on the projection plane, the first lighting device being a lighting device from which first position information is acquired. The second derivation unit 203 derives a second distance between a second coordinate indicating a position obtained by projecting a second lighting device on a projection plane parallel to the floor surface 30 and the terminal projection position, the second lighting device being a lighting device from which second position information is acquired.

The rotation angle acquisition unit 204 acquires a rotation angle of rotation of the mobile terminal 40 on the projection plane from acquisition of the first position information to acquisition of the second position information. The coordinate estimation unit 205 estimates a coordinate indicating the terminal projection position based on the first coordinate, the first distance, the second coordinate, the second distance, and the rotation angle.

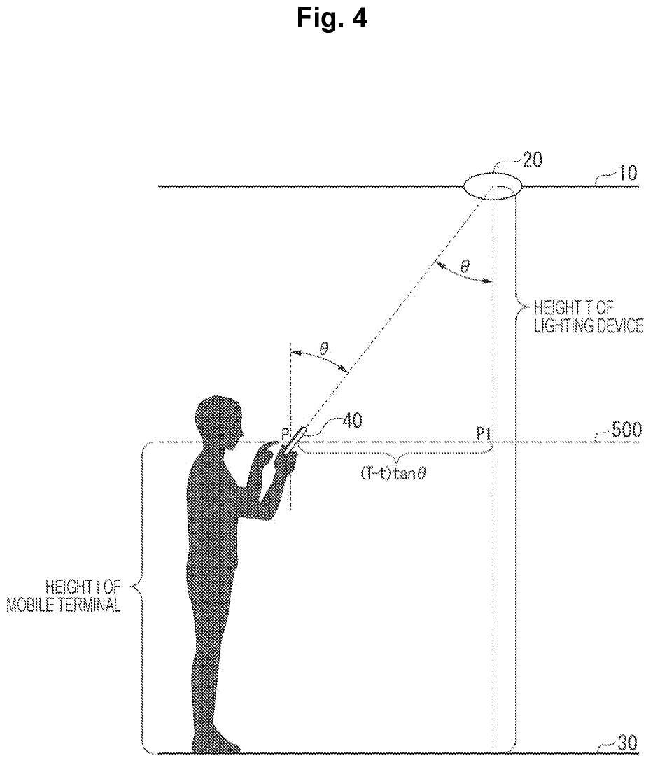

Specific processing contents in the configuration will be described. FIG. 4 is a diagram for explaining derivation of the first distance. FIG. 4 is a diagram illustrating a state where the ceiling 10 and the floor surface 30 are viewed from a lateral direction. In FIG. 4, a projection plane 500 is a plane parallel to the floor surface 30. Note that, in FIG. 4, the projection plane is provided at the same height as a height of the mobile terminal 40. On the other hand, the projection plane may be provided on any plane as long as the projection plane is parallel to the floor surface 30. The lighting device 20 is an example of a first lighting device.

In FIG. 4, as the projection plane 500, the same XY plane as the XY plane of the map is applied. That is, a coordinate on the projection plane 500 matches with a coordinate on the map.

It is assumed that a first coordinate indicating a position obtained by projecting the lighting device 20 on the projection plane 500 is P1. Since a coordinate of the lighting device 20 can be acquired from the map database, the coordinate of the lighting device 20 is set as P1. It is assumed that a terminal projection position obtained by projecting the mobile terminal 40 on the projection plane 500 is P. The mobile terminal 40 estimates a coordinate of the P.

A height T is a height of the lighting device 20 from the floor surface 30. The height T may be acquired from the map storage unit 242 in which the height is stored in advance as height data, or may be set in the mobile terminal 40 by default. A height t is a height of the mobile terminal 40 from the floor surface 30. The height t may be set in advance by each user of the mobile terminal 40, or may be acquired by means capable of measuring the height. A value (T−t) obtained by subtracting the height t from the height T indicates a length from P1 to the lighting device 20. That is, (T−t) is a length of a perpendicular line drawn from the lighting device 20 to the projection plane 500.

The mobile terminal 40 acquires, from the gyro sensor 224, an angle θ (an angle in a pitch direction) with respect to a vertical direction when the ID is acquired from the lighting device 20. The angle θ is an angle formed by a line segment connecting the mobile terminal 40 and the lighting device 20 and a perpendicular line drawn from the lighting device 20 to the projection plane 500.

Thereby, the mobile terminal 40 derives (T−t) tan θ (=r1) as the first distance. Therefore, it can be seen that the mobile terminal 40 is located on a circle of which a center is P1 and which has a radius r1.

In the mobile terminal 40, the rotation angle acquisition unit 204 acquires a rotation angle ϕ (an angle in a yaw direction) of rotation of the mobile terminal 40 on the projection plane 500 from acquisition of P1 to acquisition of second position information P2 from another lighting device 20. Note that, here, in addition to the rotation angle, the rotation angle acquisition unit 204 also acquires a rotation direction (for example, a clockwise direction or a counterclockwise direction). Further, similar to the case of derivation of the first distance, the second derivation unit 203 derives a second distance r2 between a coordinate P2 acquired based on another lighting device 20 and the terminal projection position P. It can be seen that the mobile terminal 40 is located on a circle of which a center is P2 and which has a radius r2.

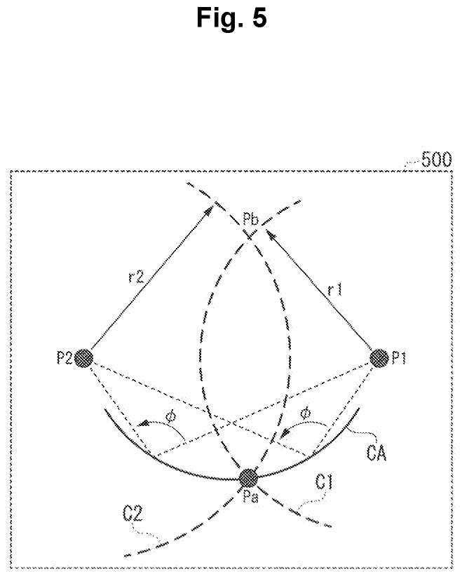

Next, the processing will be described with reference to FIG. 5. FIG. 5 is a diagram for explaining a method of estimating a coordinate of the terminal projection position P. FIG. 5 is a diagram illustrating coordinates and the like on the projection plane 500. Note that FIG. 5 illustrates the projection plane 500 viewed from the ceiling 10 side.

FIG. 5 illustrates an arc C1 of which a center is the first coordinate P1 and a radius is the first distance r1. Further, FIG. 5 illustrates an arc C2 of which a center is the second coordinate P2 and a radius is the second distance r2. Intersections of the arcs C1 and C2 are Pa and Pb.

FIG. 5 further illustrates an arc CA which passes through the first coordinate P1 and the second coordinate P2 and of which a circumferential angle is the rotation angle ϕ. As described above, since the coordinates of P1 and P2 can be acquired and r1 and r2 are also derived, the coordinate estimation unit 205 can derive the intersections Pa and Pb of the arc C1 and the arc C2.

It is assumed that the rotation angle acquisition unit 204 detects a counterclockwise direction as the rotation direction together with the rotation angle ϕ. In this case, when viewed from the mobile terminal 40, P1 is on the right side, and P2 is on the left side. Therefore, the arc CA passes through the coordinate Pa. The coordinate estimation unit 205 estimates an intersection Pa of the arc C1, the arc C2, and the arc CA, as a coordinate of the terminal projection position P.

In a case where the coordinate of the terminal projection position P is estimated, the mobile terminal 40 marks a position on the map corresponding to the coordinate. Thus, a position of the mobile terminal 40 on the map can be displayed.

In the estimation method described above, the estimation is performed using two lighting devices 20. On the other hand, the estimation may be performed using three or more lighting devices 20. For example, in a case where three lighting devices A, B, and C are used, the coordinate estimation unit 205 estimates a coordinate PAB (XAB, YAB) of the terminal projection position P using the lighting devices A and B, estimates a coordinate PBC (XBC, YBC) of the terminal projection position P using the lighting devices B and C, and estimates a coordinate PCA (XCA, YCA) of the terminal projection position P using the lighting devices A and C.

The coordinate estimation unit 205 estimates, as the coordinate of the terminal projection position P, a simple average of these coordinates by the following expression.

(PAB+PBC+PCA)/3=((XAB+XBC+XCA)/3,(YAB+YBC+YCA)/3)

Note that the estimation may be performed using a weighted average instead of a simple average. For example, in a case where the angle θ with respect to the vertical direction is smaller than a predetermined standard, it is considered that the lighting device 20 is at a position close to and directly above the mobile terminal 40. Therefore, the coordinate estimation unit 205 estimates a coordinate of the terminal projection position P by setting a weight for the coordinate estimated in a case where the angle θ is smaller than the predetermined standard to be larger than a weight for the coordinate estimated in a case where the angle θ is not smaller than the predetermined standard and calculating a weighted average of the coordinates.

In addition, since the coordinate P2 in FIG. 5 indicate the coordinate at which the mobile terminal 40 lastly acquires the ID, it can be seen that a direction in which the mobile terminal 40 is facing is a direction from the coordinate of the terminal projection position P toward the coordinate P2. As described above, the direction is also known, and thus the mobile terminal 40 can mark the direction of the mobile terminal 40 on the map.

According to the embodiment described above, it is possible to estimate the position of the mobile terminal in a case where the mobile terminal is located outside the irradiation range which is directly irradiated with light. In addition, even in a case where the mobile terminal is located within the irradiation range which is directly irradiated with light, position information may be acquired from the plurality of lighting devices. Even in a case where the position information is acquired from the plurality of lighting devices, it is possible to estimate the position of the mobile terminal 40.

### Second Embodiment

In a second embodiment, an embodiment in which the position of the mobile terminal 40 is acquired according to the first embodiment and then a configuration for coping with a case where the mobile terminal 40 further moves is added will be described.

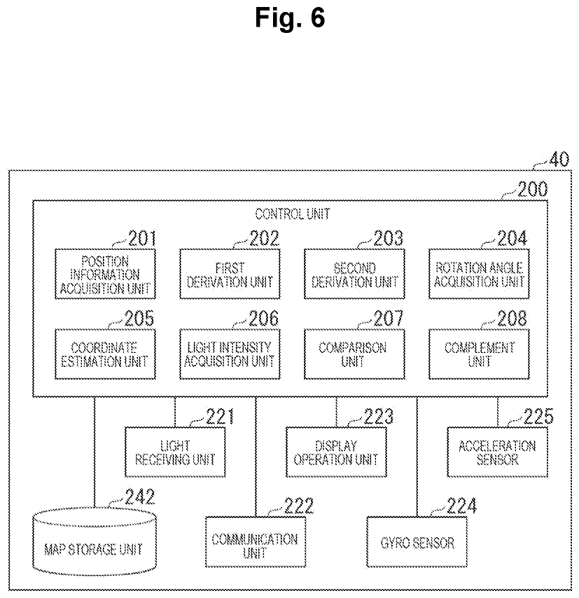

FIG. 6 is a functional block diagram illustrating a functional configuration of the mobile terminal 40 according to the second embodiment. Description of the configuration described in the first embodiment will be omitted. The mobile terminal 40 according to the second embodiment newly includes a light intensity acquisition unit 206, a comparison unit 207, and a complement unit 208 in the control unit 200. Further, an acceleration sensor 225 is newly included.

In the configuration, the acceleration sensor 225 detects movement acceleration and a movement direction of the mobile terminal 40. The light intensity acquisition unit 206 acquires an intensity of the light received by the light receiving unit 221. The light intensity acquisition unit 206 acquires intensities of the light from the plurality of lighting devices 20, and thus accuracy of the position information is improved.

The comparison unit 207 compares the ID acquired from the lighting device 20, the intensity of the light, and the angles of the yaw axis, the pitch axis, and the roll axis of the mobile terminal 40, the angles being detected by the gyro sensor 224. For example, even though the mobile terminal 40 is facing toward P1 described in the first embodiment, in a case where it is determined that the intensity of the light from the lighting device 20 located at P1 is decreased based on the angles detected by the gyro sensor 224, it can be seen that the mobile terminal 40 moves away from P1. As described above, in a case where the intensity and the angles are known, it is possible to determine whether the mobile terminal 40 moves away from P1 or P2 or approaches P1 or P2.

The complement unit 208 complements the position of the mobile terminal 40 estimated by the coordinate estimation unit 205, from the movement acceleration and the movement direction which are obtained by the acceleration sensor 225, in addition to a result obtained by the comparison unit 207. For example, it is assumed that a comparison result by the comparison unit 207 indicates that the mobile terminal 40 moves away from P1. The complement unit 208 estimates a distant direction and a movement distance in the distant direction, from the movement acceleration and the movement direction which are obtained by the acceleration sensor 225, and complements the position of the mobile terminal 40 estimated by the coordinate estimation unit 205 by adding the estimated movement distance in the distant direction.

As described above, the mobile terminal 40 according to the second embodiment complements the coordinate estimated by the coordinate estimation unit based on the light intensity, and the acceleration and the movement direction which are detected by a detection unit. Thereby, it is possible to cope with a case where the position of the mobile terminal 40 is acquired according to the first embodiment and then the mobile terminal 40 further moves. For example, in a case where light reception is temporarily interrupted, or in a case where processing in the comparison unit 207 is performed at certain timings, it is possible to complement the position of the mobile terminal 40 between the timings. Further, even in a case where the position information cannot be received and estimation by the coordinate estimation unit 205 cannot be performed, it is possible to complement the position.

In the embodiments described above, the light emitted by the lighting device 20 is not limited to visible light as long as the light can be received by an illuminance sensor or a camera, and may be near-infrared light or the like. Further, in the embodiments, information is transmitted using a blinking pattern. On the other hand, instead of a blinking pattern, a color change or a light intensity may be used.

While the embodiments of the present invention have been described in detail with reference to the drawings, specific configurations are not limited to the embodiments, and include designs and the like without departing from the gist of the present invention.

### INDUSTRIAL APPLICABILITY

The present invention can be applied to a mobile terminal that acquires position information from a lighting device which transmits position information by a change in a light output mode.

### REFERENCE SIGNS LIST

1 Position estimation system
10 ceiling
20, 20-1, 20-2, 20-3, 20-4, 20-5 Lighting device
25, 25-1, 25-2, 25-3, 25-4, 25-5 Irradiation range
30 Floor surface
40 Mobile terminal
200 Control unit
201 Position information acquisition unit
202 First derivation unit
203 Second derivation unit
204 Rotation angle acquisition unit
205 Coordinate estimation unit
206 Light intensity acquisition unit
207 Comparison unit
208 Complement unit
221 Light receiving unit
222 Communication unit
223 Display operation unit
224 Gyro sensor
225 Acceleration sensor
242 Map storage unit
500 Projection plane

1. A mobile terminal comprising:
a position information acquisition unit that acquires position information from a lighting device which transmits the position information by a change in a light output mode;
a first derivation unit that derives a first distance between a first coordinate and a terminal projection position, the first coordinate indicating a position obtained by projecting, on a projection plane parallel to a floor surface, a first lighting device from which first position information is acquired as the position information by the position information acquisition unit, and the terminal projection position being obtained by projecting the mobile terminal on the projection plane;
a second derivation unit that derives a second distance between a second coordinate and the terminal projection position, the second coordinate indicating a position obtained by projecting, on the projection plane, a second lighting device from which second position information is acquired as the position information by the position information acquisition unit;
a rotation angle acquisition unit that acquires a rotation angle of rotation of the mobile terminal on the projection plane from acquisition of the first position information to acquisition of the second position information; and
a coordinate estimation unit that estimates a coordinate indicating the terminal projection position based on the first coordinate, the first distance, the second coordinate, the second distance, and the rotation angle.

2. The mobile terminal according to claim 1,
wherein the first derivation unit derives the first distance based on an angle, which is formed by a line segment connecting the mobile terminal and the first lighting device and a perpendicular line drawn from the first lighting device to the projection plane, and a length of the perpendicular line.

3. The mobile terminal according to claim 1,
wherein the second derivation unit derives the second distance based on an angle, which is formed by a line segment connecting the mobile terminal and the second lighting device and a perpendicular line drawn from the second lighting device to the projection plane, and a length of the perpendicular line.

4. The mobile terminal according to claim 1,
wherein the coordinate estimation unit estimates, as the coordinate indicating the terminal projection position, a coordinate of an intersection of an arc of which a center is the first coordinate and a radius is the first distance, an arc of which a center is the second coordinate and a radius is the second distance, and an arc which passes through the first coordinate and the second coordinate and of which a circumferential angle is the rotation angle.

5. The mobile terminal according to claim 1, further comprising:
a light intensity acquisition unit that acquires a light intensity of the lighting device;
a detection unit that detects movement acceleration and a movement direction of the mobile terminal; and
a complement unit that complements the coordinate estimated by the coordinate estimation unit based on the light intensity acquired by the light intensity acquisition unit, and the acceleration and the movement direction which are detected by the detection unit.

6. A control method of a mobile terminal, the method comprising:
a position information acquisition step of acquiring position information from a lighting device which transmits the position information by a change in a light output mode;
a first derivation step of deriving a first distance between a first coordinate and a terminal projection position, the first coordinate indicating a position obtained by projecting, on a projection plane parallel to a floor surface, a first lighting device from which first position information is acquired as the position information in the position information acquisition step, and the terminal projection position being obtained by projecting the mobile terminal on the projection plane;
a second derivation step of deriving a second distance between a second coordinate and the terminal projection position, the second coordinate indicating a position obtained by projecting, on the projection plane, a second lighting device from which second position information is acquired as the position information in the position information acquisition step;
a rotation angle acquisition step of acquiring a rotation angle of rotation of the mobile terminal on the projection plane from acquisition of the first position information to acquisition of the second position information; and
a terminal estimation derivation step of deriving a coordinate indicating the terminal projection position based on the first coordinate, the first distance, the second coordinate, the second distance, and the rotation angle.
